(19) United States
(12) Patent Application Publication
(10) Pub. No.: US 2017/0117762 A1
(43) Pub. Date: Apr. 27, 2017

(54) PERMANENT-MAGNET DYNAMO-ELECTRIC MACHINE AND COMPRESSOR USING THE SAME

(71) Applicant: JOHNSON CONTROLS-HITACHI AIR CONDITIONING TECHNOLOGY (HONG KONG) LIMITED, HONG KONG (CN)

(72) Inventors: Ryouichi TAKAHATA, Tokyo (JP); Tsenghong LIN, Tokyo (JP); Syuuji HASEGAWA, Tokyo (JP); Satoshi NAKAMURA, Tokyo (JP)

(73) Assignee: Hitachi Appliances, Inc., Tokyo (JP)

(21) Appl. No.: 15/302,007

(22) PCT Filed: Mar. 24, 2015
(86) PCT No.: PCT/JP2015/058900

§ 371 Date: Oct. 5, 2016

(30) Foreign Application Priority Data
Apr. 17, 2014 (JP) 2014-085114

(51) Int. Cl. H02K 1/27; F04C 18/02; F04C 29/02; F25B 31/02

(52) U.S. Cl. CPC H02K 1/276; F25B 31/02; F25B 31/026; F04C 18/0215; F04C 29/02; F04C 2240/40

(57) ABSTRACT

A rotor is formed such that a concave section is formed on the q axis and a gap between the concave section and a tooth of a stator is larger than a gap between an outer circumferential section and the tooth on the d axis. The concave section is formed in a substantially trapezoidal shape and formed such that an opening degree θp2 on an outer circumference side is large with respect to an opening degree θp1 on an inner circumference side. The opening degree θp2 is set within a range of approximately 60 degrees in the electrical angle. A slit is not formed near the d axis on the outer circumference side of the permanent magnet insertion hole and a plurality of slits are formed on left and right both sides a predetermined distance or more apart from the d axis.

### TECHNICAL FIELD

The present invention relates to a permanent magnet type dynamo electric machine including, in a rotor, a permanent magnet for a field system and, more particularly, to a permanent magnet type dynamoelectric machine used in a compressor of an air conditioner, a refrigerator, a freezer, or a showcase.

### BACKGROUND ART

In the permanent magnet type dynamoelectric machine of this type, concentrated winding and a permanent magnet of neodymium of rare earth have been respectively adopted as a stator winding and a field system to achieve a reduction in size and improvement of efficiency. However, on the other hand, there has been a problem of a nonlinear magnetic characteristic of a core involved in an increase in output density due to the reduction in size and the improvement of efficiency. A space harmonic magnetic flux has been increased by the adoption of the concentrated winding. Various measures have been taken against the problems.

For example, in a permanent magnet type dynamoelectric machine described in JP-A-2008-245384, it is proposed to provide a plurality of slits by etching that extend from an outer circumference side of a permanent magnet embedded in a rotor to a rotor outer circumference side.

### CITATION LIST

### Patent Literature

### Patent Literature 1: JP-A-2008-245384

### SUMMARY OF INVENTION

### Technical Problem

Efficiency of a permanent magnet type dynamoelectric machine has been dramatically improved by adoption of a concentrated winding stator and adoption of high-magnetic flux density magnet. On the other hand, as opposed to a distributed winding stator, in the concentrated winding stator, a harmonic magnetic flux increases in principle. In addition, as a result, a permanent magnet having high magnetic flux density facilitates the harmonic magnetic flux. That is, nonlinearity of a core involved in an increase in output density due to a reduction in size and improvement of efficiency also increases. In particular, when load torque is large, there is a problem of torque (output) insufficiency due to a decrease in a power factor.

On the other hand, in Patent Literature 1, a harmonic magnetic flux on a gap surface is reduced by providing the plurality of slits by etching that extend from the outer circumference side of the permanent magnet embedded in the rotor to the rotor outer circumference side. Consequently, it is possible to convert an induced electromotive force waveform into a sine wave and convert an armature current into a sine wave. A harmonic magnetic flux generated by interaction of an induced electromotive force and the armature current is reduced.

However, for example, in the invention of Patent Literature 1, although the permanent magnetic type dynamoelectric machine can obtain high efficiency in medium and low speed regions, in a high speed region, when load torque is large or an armature winding of a motor is increased to have high inductance, since the influence of a magnetic flux (a q-axis magnetic flux) due to a torque current increases, a voltage phase advances and a power factor decreases. As a result, a problem occurs in that the permanent magnetic type dynamoelectric machine cannot be controlled to high torque and high efficiency by a driving device such as an inverter.

An object of the present invention is to provide a permanent magnet type dynamoelectric machine that can suppress a power factor decrease due to advance of a voltage phase involved in the influence of a q-axis magnetic flux without deteriorating performance such as motor efficiency and a control characteristic in a high speed region and has small size and high efficiency and a compressor using the permanent magnet type dynamoelectric machine.

### Solution to Problem

An example of the present invention for achieving the object is explained. There is provided a permanent magnet type dynamoelectric machine including: a stator including teeth wound with an armature winding; a rotor disposed on an inside of the stator via a gap; a plurality of magnet insertion holes formed in the rotor; and a permanent magnet disposed in each of the plurality of magnet insertion holes. When a magnetic flux axis of the permanent magnet is represented as a d axis and an axis orthogonal to the d axis in an electrical angle is represented as a q axis, the rotor is formed such that a concave section recessed to an inner circumference side is formed on the q axis and a gap between the concave section and the tooth is larger than a gap between an outer circumferential section and the tooth of the stator on the d axis . The concave section is formed in a substantially trapezoidal shape and formed such that an opening degree θp2 at left and right both ends on an outer circumference side is large with respect to an opening degree θp1 at left and right both ends on an inner circumference side. The opening degree θp2 is set within a range of approximately 60 degrees in the electrical angle. A slit is not formed near the d axis on the outer circumference side of the permanent magnet insertion hole and a plurality of slits are formed on left and right both sides a predetermined distance or more apart from the d axis.

### Advantageous Effect of Invention

As explained above, according to the present invention, it is possible to provide a permanent magnet type dynamoelectric machine that can suppress a power factor decrease due to advance of a voltage phase involved in the influence of a q-axis magnetic flux without deteriorating performance such as motor efficiency and a control characteristic and has small size and high efficiency and a compressor using the permanent magnet type dynamoelectric machine. Other features, action, and effects of the present invention are explained in detail in the following embodiments.

### BRIEF DESCRIPTION OF THE DRAWINGS

FIG. 1 is a sectional view of a first embodiment of a permanent magnet type dynamoelectric machine according to the present invention.

FIG. 2 is a sectional view showing a rotor core shape in the first embodiment of the permanent magnet type dynamoelectric machine according to the present invention.

FIG. 3 is a schematic diagram of a vector diagram of a permanent magnet type dynamoelectric machine according to a conventional invention.

FIG. 4 is a schematic diagram of a vector diagram of the permanent magnet type dynamoelectric machine according to the present invention.

FIG. 5 is torque in the first embodiment of the permanent magnet type dynamoelectric machine according to the present invention.

FIG. 6 is a sectional view showing a rotor core shape in a second embodiment of the permanent magnet type dynamoelectric machine according to the present invention.

FIG. 7 is a sectional structure of a compressor according to the present invention.

### DESCRIPTION OF EMBODIMENTS

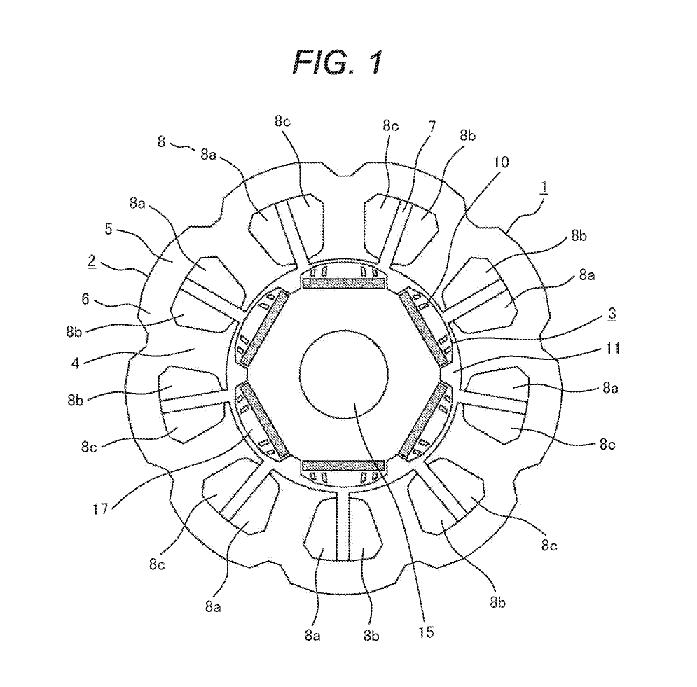

Embodiments of the present invention are explained in detail below with reference to FIG. 1 to FIG. 7. In the figures, common reference numerals and signs indicate the same objects. A permanent magnet type dynamoelectric machine having six poles is explained below. A ratio of the number of poles of a rotor and the number of slots of a stator is set to 2:3. However, substantially the same effects can be obtained at other ratios of the number of poles and the number of slots.

### First Embodiment

FIG. 1 is a sectional view of a permanent magnet type dynamoelectric machine in a first embodiment of the present invention.

In FIG. 1, a permanent magnet type dynamoelectric machine 1 is configured from a stator 2 and a rotor 3 that is disposed on the inner side of the stator 2 via a predetermined gap and rotates together with a shaft. The stator 2 is configured with a stator core 6 (an electromagnetic steel plate) stacked in the axial direction and includes an annular core back 5 and a plurality of teeth 4 projecting toward the radial direction inner side from the core back 5. The plurality of teeth 4 are arrayed at substantially equal intervals in the circumferential direction. A slot 7 is formed between the teeth 4 adjacent to each other. An armature winding 8 (including a U-phase winding 8a, a V-phase winding 8b, and a W-phase winding 8c of three-phase winding) of a concentrated winding is wound on the slot 7 to surround the tooth 4. Since the permanent magnet type dynamoelectric machine 1 in this embodiment includes six poles and nine slots, a slot pitch is 120 degrees in an electrical angle.

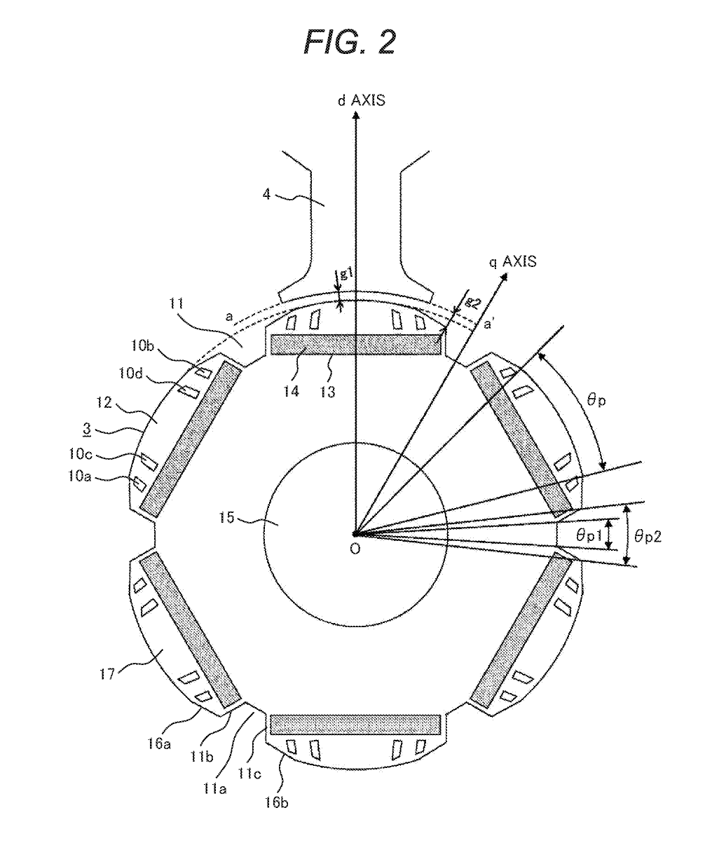

FIG. 2 is a sectional view of the rotor core of the permanent magnet type dynamoelectric machine according to this embodiment.

In FIG. 2, the rotor 3 is configured with a rotor core 12, in the center of which a shaft hole 15 is formed, stacked. A plurality of convex sections are formed at substantially equal intervals on the outer circumference side of the rotor 3. The plurality of convex sections 17 are convex toward the outer circumference side. In the respective convex sections 17, a plurality of permanent magnet insertion holes 13 having a substantially linear shape are formed near the outer circumference side surface. A permanent magnet 14 made of, for example, neodymium of rare earth is inserted into each of the plurality of permanent magnet insertion holes 13. A direction of a magnetic flux formed by magnetic poles of the permanent magnet 14, that is, an axis connecting the longitudinal direction center of the permanent magnet 14 and the rotation axis center is represented as a d axis (a magnetic flux axis) and an axis electrically and magnetically orthogonal to the d axis (an axis between permanent magnets) is represented as a q axis.

In the rotor 3, a concave section 11 recessed to the inner circumference side on the q axis between the magnetic poles of the permanent magnets 14 disposed in the convex sections 17 adjacent to each other is provided. Each of the convex sections 17 is configured by an outermost circumferential section that is located further on the outer circumference side than the concave section 11 and in which gap length (a gap) to the tooth 4 of the stator 2 is shortest length g1 and by an outer circumferential section having gap length g2 longer than g1. The outer circumferential shape of the arcuate outermost circumferential section having the gap length g1 in the convex section 17 of the rotor 3 is formed in an arcuate shape. The outermost circumferential section is configured such that an electrical angle θp is 90° to 120°.

In the rotor 3, a slit is not formed near the d axis on the outer circumference side of the permanent magnet insertion hole 13 (the permanent magnet 14). A plurality of slits 10 (10a to 10d) are formed symmetrically on the left and right both sides of the d axis a predetermined distance or more apart from the d axis. The plurality of slits are inclined to the center side of the permanent magnet 14 respectively corresponding to the slits toward the outer circumference side. Consequently, it is possible to collect magnetic fluxes of the permanent magnet 14 in the tooth 4.

Therefore, it is seen that, with the slits 10, it is possible to convert an induced electromotive force waveform into a sine wave and convert an armature current into a sine wave and it is possible to reduce a harmonic magnetic flux generated by interaction of the induced electromotive force and the armature current. Therefore, in this structure as well, the slits 10 are provided to suppress armature reaction and reduce a harmonic component of a magnetic flux in the machine.

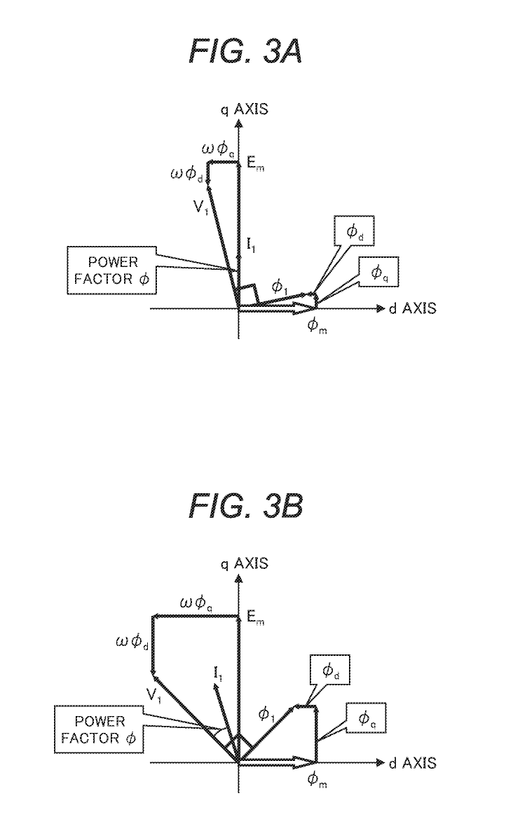

FIG. 3 is a schematic diagram of a vector diagram of a permanent magnet type dynamoelectric machine in an embodiment of a conventional one. In the figure, (a) is a vector diagram of the permanent magnet type dynamoelectric machine during low speed/low load torque and (b) is a vector diagram of the permanent magnet type dynamoelectric machine during high speed/high load torque.

In the figure, Φm indicates a magnetic flux flowing on the d axis from the permanent magnet 14 and is indicated by a fixed value. As magnetic fluxes generated when an electric current flows to a stator during operation, there are a magnetic flux Φd generated by a d-axis current and a magnetic flux Φq generated by a q-axis current in a coordinate system d-q axis for performing control of the permanent magnet type dynamoelectric machine. In a main magnetic flux Φ1, which is a magnetic flux of the entire permanent magnet type dynamoelectric machine, Φm is affected by Φd and Φq and determined. When Φ1 is determined, an applied voltage V1 and a motor (armature) current I1 are determined. Consequently, a power factor is determined.

During the low speed/low load torque shown in FIG. 3(a), phases of the main magnetic flux Φ1 of the permanent magnet type dynamoelectric machine and the magnetic flux Φm of the permanent magnet do not greatly shift even in the system of Patent Literature 1. Therefore, it is possible to stably drive the permanent magnet type dynamoelectric machine. That is, a voltage drop from an induced voltage Em to the applied voltage V1, namely a voltage drop on the d axis and the q axis are not very large.

However, during the high speed/high load torque shown in FIG. 3(b), since a large amount of the q-axis current needs to be fed in order to increase torque, a magnetic flux on the q axis increases. Therefore, the phase of the main magnetic flux Φ1 of the permanent magnet type dynamoelectric machine shifts more greatly than the phase of Φm. The permanent magnet type dynamoelectric machine is controlled by an inverter on the basis of a main magnetic flux Φ1. Therefore, an armature current has an advanced phase, a power factor is deteriorated, and the torque of the permanent magnet type dynamoelectric machine decreases to cause efficiency deterioration.

Therefore, in this embodiment, as shown in FIG. 2, the rotor 3 is formed such that gap length between the concave section 11 formed on the q axis and the tooth 4 of the stator 2 is larger than gap lengths (g1 and g2) on the d-axis side. That is, in the outer circumference of the rotor 3, the concave section 11 is further recessed to the inner circumference side than both of a part where the gap length between the stator 2 and the tooth 4 in the convex section 17 is the shortest length g1 and a part where the gap length is g2 longer than g1.

In this embodiment, the concave section 11 is formed in a substantially trapezoidal shape (a substantial bathtub shape) as shown in FIG. 2. The concave section 11 is connected to substantially linear cut sections (16a and 16b) of the convex sections 17 adjacent to the concave section 11 respectively on the left and the right on the outer circumference side to form the outer circumference section of the rotor 3. More specifically, the concave section 11 is formed by connecting a substantially linear inner circumference side linear section 11a located along a rotating direction between the permanent magnets 14 adjacent to each other, a substantially linear rotating direction side linear section 11b located to expand to the rotating direction side from a rotating direction side end portion of the inner circumference side linear section 11a, and a substantially linear counter-rotating direction side linear section 11c located to expand to a counter-rotating direction side from a counter-rotating direction side end portion of the inner circumference side linear section 11a.

The inner circumference side linear section 11a is located on the inner circumference side in the direction along the short side of the permanent magnet 14. Note that a clockwise direction is explained as the rotating direction. However, the rotor 3 may rotate counterclockwise.

The rotating direction side linear section 11b of the concave section 11 is connected to, at an outer circumference side end portion, a substantially linear rotating direction side cut section 16a of the convex section 17 adjacent to the concave section 11. The rotating direction side cut section 16a is formed to incline to the outer circumference side from the outer circumference side end portion toward the rotating direction. The counter-rotating direction side linear section 11c of the concave section 11 is connected to, at an outer circumference side end portion, a substantially linear counter-rotating direction side cut section 16b of the convex section 17 adjacent to the concave section 11. The counter-rotating direction side cut section 16b is formed to incline to the outer circumference side from the outer circumference side end portion toward the counter-rotating direction.

Note that gap length between the outer circumference side end portions of the rotating direction side linear section 11b and the counter-rotating direction side linear section 11c and the tooth 4 of the stator core 6 or gap length between the inner circumference side end portions of the rotating direction side cut section 16a and the counter-rotating direction side cut section 16b and the tooth 4 of the stator 2 is g2 explained above. In this embodiment, the rotating direction side cut section 16a and the counter-rotating direction side cut section 16b of the convex section 17 are formed in a substantially linear shape as explained above. Therefore, it is possible to easily manufacture the permanent magnet type dynamoelectric machine and achieve a reduction in production cost.

In each of the convex sections 17 of the rotor 3, the rotating direction side cut section 16a is directly connected to, at an outer circumference side end portion thereof, an arcuate outer circumferential section located on the outer circumference side of the permanent magnet 14. Similarly, the counter-rotating direction side cut section 16b is directly connected to, at an outer circumference side end portion thereof, the arcuate outer circumferential section located on the outer circumference side of the permanent magnet 14. In this embodiment, the convex section 17 is formed such that, in a state in which the convex section 17 is located in a position corresponding to the tooth 4, width between the outer circumference side end portion of the rotating direction side cut section 16a and the outer circumference side end portion of the counter-rotating direction side cut section 16b corresponds to width in the rotating direction of the tooth 4 of the stator 2. More specifically, the width between the outer circumference side end portion of the rotating direction side cut section 16a and the outer circumference side end portion of the counter-rotating direction side cut section 16b is equal to or smaller than the width in the rotating direction of the tooth 4 of the stator 2.

By forming the convex section in this way, it is possible to allow a magnetic flux by the permanent magnet to directly flow to the tooth 4. It is possible to suppress the magnetic flux from leaking to the outer side of the tooth 4. Therefore, it is possible to improve an induced electromotive force of the motor and reduce the q-axis current by the improvement of the induced electromotive force. Therefore, it is possible to generate the same torque with a smaller q-axis current. Consequently, a copper loss (3×(resistance)×(motor current)) of the motor decreases. It is possible to improve efficiency.

In this embodiment, in the concave section 11, when an opening degree (an electrical angle) of the inner circumference side linear section 11a is represented as θp1 and an opening degree between the respective outer circumference side end portions of the rotating direction side linear section 11b and the counter-rotating direction side linear section 11c is represented as θp2 (an electrical angle), the opening degrees are set to be θp1<θp2. In this embodiment, θp2 is set to be within a range of 60° in an electrical angle. Note that, in the above explanation, the concave section 11 is explained as having the trapezoidal shape. However, this embodiment is not limited to this. The concave section 11 only has to have a shape expanding to the left and the right from the inner circumference side toward the outer circumference side of the concave section 11. That is, the concave section 11 only has to be formed such that the opening degree θp2 at the left and right both ends on the outer circumference side is large with respect to the opening degree θp1 at the left and right both ends on the inner circumference side of the concave section 11.

A sectional area surrounded by the concave section 11 is desirably larger than an area surrounded by the rotating direction side cut section 16a, a dotted line in FIG. 2 of the extension of the arcuate shape of the convex section 17, and a perpendicular from the inner circumference side end portion of the rotating direction side cut section 16a to the dotted line. Similarly, a sectional area surrounded by the concave section 11 is desirably larger than an area surrounded by the counter-rotating direction side cut section 16b, the dotted line in FIG. 2 of the extension of the arcuate shape of the convex section 17, and a perpendicular from the inner circumference side end portion of the counter-rotating direction side cut section 16b to the dotted line.

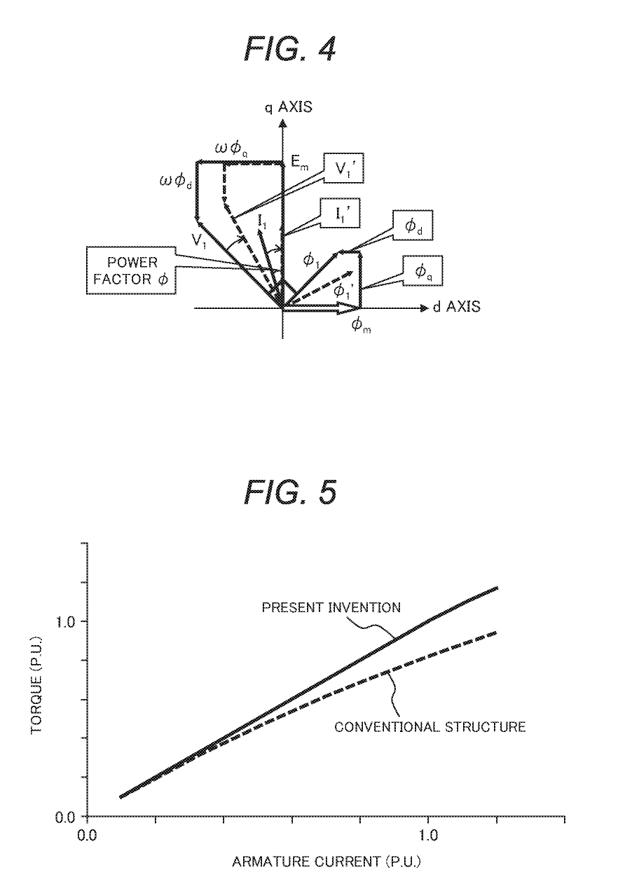

FIG. 4 is a schematic diagram of a vector diagram of the permanent magnet type dynamoelectric machine in this embodiment.

In FIG. 4, as explained above, in the substantially trapezoidal concave section 11 of the rotor core 12, by setting the opening degree θp2 between the outer circumference side end portions of the rotating direction side linear section 11b and the counter-rotating direction side linear section 11c larger than the opening degree θp1 of the respective inner circumference side linear section 11a, it is possible to collect magnetic fluxes of the permanent magnet. In particular, as a result of earnest examination, the inventors have found that it is desirable to form the concave section 11 such that a relation between a machine angle θp1′ corresponding to the opening degree θp1 of the inner circumference side linear section 11a and a machine angle θp2′ corresponding to the opening degree θp2 between the respective outer circumference side end portions of the rotating direction side linear section 11b and the counter-rotating direction side linear section 11c is the machine angle θp1′/machine angle θp2′≧0.4.

By setting the inner circumference side linear section 11a long with respect to the length between the respective outer circumference side end portions of the rotating direction side linear section 11b and the counter-rotating direction side linear section 11c as much as possible in this way, it is possible to greatly increase magnetic resistance on the q axis to suppress the influence of the armature reaction and greatly reduce the harmonic component of the magnetic flux in the machine.

According to this embodiment explained above, the magnetic flux flowing on the q axis can be reduced compared with FIG. 3(b) as shown in FIG. 4. Therefore, it is possible to improve a relation between the applied voltages V₁′ and I₁′. It is possible to improve the phase advance of Φ1 and Φm. Therefore, when high load torque and inductance of the motor are large in a high speed region, it is possible to suppress the power factor decrease due to the influence of the armature reaction. As a result, it is possible to suppress a decrease in torque and reduce the size and improve the efficiency of the permanent magnet type dynamoelectric machine 1.

FIG. 5 is a diagram showing torque (a high speed region) in the first embodiment of the permanent magnet type dynamoelectric machine according to this embodiment. In FIG. 5, a rated current is represented as 1 p. u. and standardized and the torque (the high speed region) in the first embodiment of the permanent magnet type dynamoelectric machine at the time when the rated current is fed is represented as 1 P. U. and standardized. It is seen from FIG. 5 that the torque in the first embodiment of the permanent magnet type dynamoelectric machine according to this embodiment is larger than the torque in the conventional structure.

Consequently, by adopting the permanent magnet type dynamoelectric machine explained above, it is possible to provide a permanent magnet type dynamoelectric machine that can suppress a power factor decrease due to the influence of armature reaction, suppress a decrease in torque, and has small size and high efficiency.

### Second Embodiment

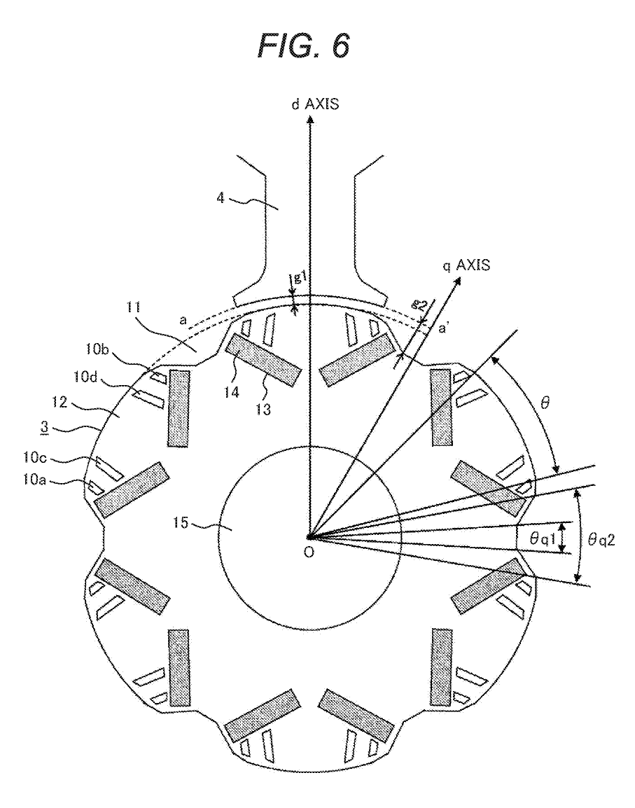

FIG. 6 is a sectional view of a rotor core shape in a second embodiment of the permanent magnet type dynamoelectric machine according to the present invention.

In FIG. 6, components same as the components shown in FIG. 2 are denoted by the same reference numerals and signs. The figure is different from FIG. 2 in that two permanent magnets 14 are included per one pole and disposed in a V shape convex to the shaft hole 15. Note that it goes without saying that, in a rotor structure in which the permanent magnets 14 are disposed in this way, as in the first embodiment, it is possible to suppress a power factor decrease due to the influence of armature reaction, suppress a decrease in torque, and reduce size and improve efficiency. Therefore, even when the permanent magnets 14 are disposed in this way, it is possible to obtain effects same as the effects in FIG. 2.

### Third Embodiment

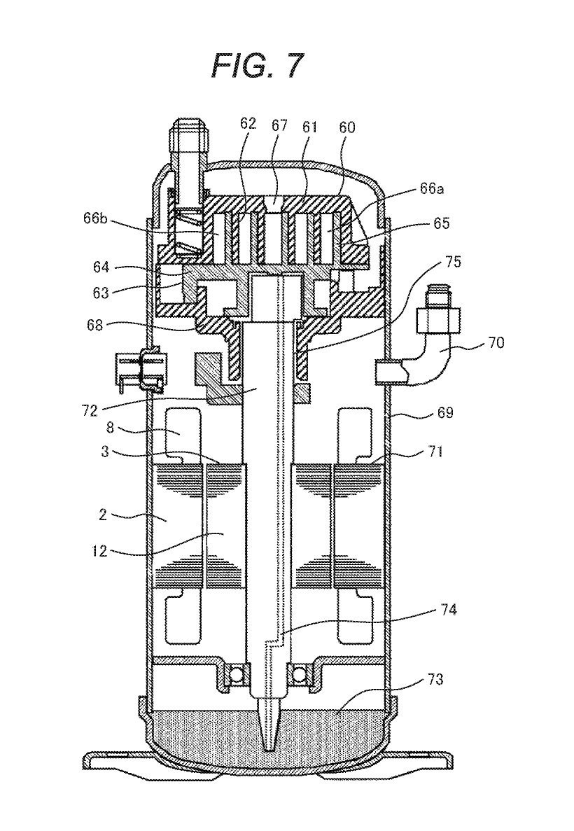

FIG. 7 is a sectional view of a compressor mounted with a third embodiment of the permanent magnet type dynamoelectric machine according to the present invention.

In FIG. 7, in a cylindrical compression container 69, a spiral wrap 62 standing straight on an endplate 61 of a fixed scroll member 60 and a spiral wrap 65 standing straight on an end plate 64 of a orbiting scroll member 63 are meshed with each other to forma compression mechanism section. When the compression mechanism section is driven by the permanent magnet type dynamoelectric machine 1, the turning scroll member 63 is turned by a crankshaft 72, whereby the compression mechanism section performs a compressing operation.

Among compression chambers 66 (66a, 66b, . . . ) formed by the fixed scroll member 60 and the orbiting scroll member 63, a compression chamber located on the outermost diameter side moves toward the center of both the scroll members 63 and 60 according to the turning. The capacity of the compression chamber gradually decreases. When the compression chambers 66a and 66b reach the vicinity of the center of both the scroll members 60 and 63, compressed gas in both the compression chambers 66 is discharged from a discharge port 67 communicating with the compression chambers 66. The discharged compressed gas reaches the inside of the compression container 69 below the frame 68 passing through a gas passage (not shown in the figure) provided in the fixed scroll member 60 and a frame 68 and is discharged to the outside of the electric compressor from a discharge pipe 70 provided on a sidewall of the compression container 69. The permanent magnet type dynamoelectric machine 1 that drives the electric compressor is controlled by a separately placed inverter (not shown in the figure) and rotates at rotating speed suitable for the compressing operation.

The permanent magnet type dynamoelectric machine 1 is configured from the stator 2 and the rotor 3. In the crankshaft 72 provided in the rotor 3, the upper side is a crankshaft. An oil passage 74 is formed on the inside of the crankshaft 72. Lubricant in an oil sump part 73 present below the compression container 69 is supplied to a sliding bearing 75 via the oil passage 74 according to rotation of the crankshaft 72. By applying the permanent magnet type dynamoelectric machine 1 in the first embodiment or the second embodiment explained above to the compressor having such a configuration, it is possible to achieve improvement of efficiency of the compressor.

Incidentally, in most of present air conditioners for home use and business use, an R410A refrigerant is encapsulated in the compression container 69. The ambient temperature of the permanent magnet type dynamoelectric machine 1 is often 80° C. or higher. In future, the ambient temperature further rises if an R32 refrigerant having a smaller global warming coefficient is adopted more. In particular, when the permanent magnet 14 is configured by a neodymium magnet, residual magnetic flux density falls when temperature rises. An armature current increases to secure the same output. Therefore, it is possible to supplement the efficiency deterioration by applying the permanent magnet type dynamoelectric machine described in the first embodiment or the second embodiment. Note that in applying the permanent magnet type dynamoelectric machine described in the first embodiment or the second embodiment to the compressor in this embodiment, a type of a refrigerant is not limited. Note that a compressor configuration may be the scroll compressor shown in FIG. 7, may be a rotary compressor, or may be configurations including other compression mechanisms.

According to this embodiment, as explained above, it is possible to realize a permanent magnet type dynamoelectric machine having small size and high efficiency. If the permanent magnet type dynamoelectric machine according to the first embodiment or the second embodiment is applied, it is possible to expand an operation range, for example, it is possible to perform high-speed operation. Further, when refrigerants such as He and R32 are used, compared with refrigerants such as R22, R407C, and R410A, a leak from a gap of the compressor is large. In particular, during low-speed operation, a ratio of a leak to a circulation amount markedly increases. Therefore, deterioration in efficiency is large. For improvement of the efficiency during a low circulation amount (low-speed operation), it could be efficient means to reduce a leak loss by reducing the size of the compression mechanism section and increasing the number of revolutions to obtain the same circulation amount. However, a maximum number of revolutions also needs to be increased to secure a maximum circulation amount. If the compressor including the permanent magnet type dynamoelectric machine 1 according to this embodiment is adopted, it is possible to increase the maximum torque and the maximum number of revolutions and it is possible to reduce a loss in a high speed region. Therefore, when a large quantity of the refrigerant such as He or R32 is included in a freezing cycle (e.g., 70 weight % or more), this could be effective means for improvement of efficiency.

Consequently, if the permanent magnet type dynamo electric machine is applied to various compressors for air conditioning use, business use, and the like, it is possible to provide a compressor having high efficiency.

### REFERENCE SIGNS LIST

1 permanent magnet type dynamoelectric machine (motor for driving)
2 stator
3 rotor
4 teeth
5 core back
6 stator core
7 slot
8 armature winding
10 slit
11 concave section
12 rotor core
13 permanent magnet insertion hole
14 permanent magnet
15 shaft hole
60 fixed scroll member
61, 64 end plate
62, 65 spiral wrap
63 orbiting scroll member
66 compression chamber
67 discharge port
68 frame
69 compression container
70 projection pipe
72 crankshaft
73 oil samp part
74 oil passage
75 sliding bearing

1. A permanent magnet type dynamoelectric machine comprising:
a stator including teeth wound with an armature winding;
a rotor disposed on an inside of the stator via a gap;
a plurality of magnet insertion holes formed in the rotor; and
a permanent magnet disposed in each of the plurality of magnet insertion holes, wherein
when a magnetic flux axis of the permanent magnet is represented as a d axis and an axis orthogonal to the d axis in an electrical angle is represented as a q axis, the rotor is formed such that a concave section recessed to an inner circumference side is formed on the q axis and a gap between the concave section and the tooth is larger than a gap between an outer circumferential section and the tooth of the stator on the d axis,
the concave section is formed in a substantially trapezoidal shape and formed such that an opening degree θp2 at left and right both ends on an outer circumference side is large with respect to an opening degree θp1 at left and right both ends on an inner circumference side, and the opening degree θp2 is set within a range of approximately 60 degrees in the electrical angle, and
a slit is not formed near the d axis on the outer circumference side of the permanent magnet insertion hole and a plurality of slits are formed on left and right both sides a predetermined distance or more apart from the d axis.

2. The permanent magnet type dynamoelectric machine according to claim 1, wherein the concave section is formed by connecting an inner circumference side linear section located along a rotating direction between the permanent magnets adjacent to each other, a rotating direction side linear section located to expand to the rotating direction side from a rotating direction side end portion of the inner circumference side linear section, and a counter-rotating direction side linear section located to expand to a counter-rotating direction side from a counter-rotating direction side end portion of the inner circumference side linear section.

3. The permanent magnet type dynamoelectric machine according to claim 2, wherein
the rotor includes a plurality of convex sections convex to the outer circumference side,
the rotating direction side linear section of the concave section is connected to, at an outer circumference side end portion, a substantially linear rotating direction side cut section of the convex section adjacent to the concave section, and the rotating direction side cut section is formed to incline to the outer circumference side from the outer circumference side end portion toward the rotating direction, and
on the other hand, a counter-rotating direction side linear section of the concave section is connected to, at an outer circumference side end portion, a substantially linear counter-rotating direction side cut section of the convex section adjacent to the concave section, and the counter-rotating direction side cut section is formed to incline to the outer circumference side from the outer circumference side end portion toward the counter-rotating direction.

4. The permanent magnet type dynamoelectric machine according to claim 3, wherein
in each of the convex sections, the rotating direction side cut section is directly connected to, at an outer circumference side end portion thereof, an arcuate outer circumferential section located on the outer circumference side of the permanent magnet, and,
on the other hand, the counter-rotating direction side cut section is directly connected to, at an outer circumference side end portion thereof, the arcuate outer circumferential section located on the outer circumference side of the permanent magnet.

5. The permanent magnet type dynamoelectric machine according to claim 2, wherein each of the concave sections is formed such that a relation between a machine angle θp1′ corresponding to an electrical angle θp1 of the inner circumference side linear section and a machine angle θp2′ corresponding to an electrical angle θp2 between the respective outer circumference side end portions of the rotating direction side linear section and the counter-rotating direction side linear section is θp1′/θp2≧0.4.

6. The permanent magnet type dynamoelectric machine according to claim 1, wherein the plurality of slits are inclined to a center side of the permanent magnet corresponding to the slits toward the outer circumference side.

7. The permanent magnet type dynamoelectric machine according to claim 4, wherein the arcuate outer circumferential section of each of the convex sections is set within a range of approximately 90 degrees to approximately 120 degrees in an electrical angle.

8. A compressor including, on an inside, a compression mechanism section that compresses a refrigerant and a motor section that drives the compression mechanism section, wherein the permanent magnet type dynamoelectric machine according to claim 1 is mounted on the motor section.

9. The compressor according to claim 8, wherein, in a freezing cycle in which the compressor is adopted, R32 is encapsulated as the refrigerant by 70 weight % or more.
